(19) United States
(12) Patent Application Publication
(10) Pub. No.: US 2014/0156394 A1
(43) Pub. Date: Jun. 5, 2014

(54) Targeted Advertisement Generation For Travelers

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/691,210

(22) Filed: Nov. 30, 2012

(51) Int. Cl. G06Q 30/02

(52) U.S. Cl. CPC G06Q 30/0255
USPC 705/14.53

(57) ABSTRACT

Systems and methods are disclosed herein for generating targeted advertisements to traveling consumers. A user's location is tracked or inferred and compared to a home region identified for the user. For user's located with in a home region targeted advertisements are selected according to a user profile generated from analysis of the user's purchases over time. Upon detecting the user located outside the home region, selection of advertisements according to the user's home region profile may be suspended and advertisements may be selected according to one or more of a generic traveling consumer model, a traveling consumer category model, and a user-specific traveling profile.

### BACKGROUND

1. Field of the Invention

This invention relates to generating targeted advertisements for customers.

2. Background of the Invention

A consumer's behavior can be tracked from past purchases. In general, a large number of purchases over an extended period of time is needed in order to characterize a consumer's preferences and habits. By itself, or combined with demographic data, this data can be used to generate targeted advertising that is tailored to a consumer. Targeted advertising is helpful for the merchant inasmuch as a consumer is more likely to respond favorably. Targeted advertising is also helpful for consumers inasmuch as the advertisements to which the consumer is exposed are more relevant and may help educate the consumer regarding products that are likely to be of interest to the consumer.

However, some or all the information that may be gathered regarding a consumer's purchasing habits becomes irrelevant when the consumer is traveling. The systems and methods disclosed herein provide novel approaches for providing targeted advertising to a consumer while traveling notwithstanding this issue.

### BRIEF DESCRIPTION OF THE DRAWINGS

In order that the advantages of the invention will be readily understood, a more particular description of the invention will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a system for methods in accordance with embodiments of the present invention;

FIG. 2 is a block diagram of a computing device suitable for implementing embodiments of the present invention;

FIG. 3 is a process flow diagram of a method for generating targeted advertisements for a traveling consumer in accordance with an embodiment of the present invention;

FIG. 4 is a process flow diagram of an alternative method for generating targeted advertisements for a traveling consumer in accordance with an embodiment of the present invention;

FIG. 5 is a process flow diagram of a method for generating recommendations for a traveling consumer using a model in accordance with an embodiment of the present invention; and

FIG. 6 is a process flow diagram of a method for selecting a model for selecting advertisements for a traveling consumer in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

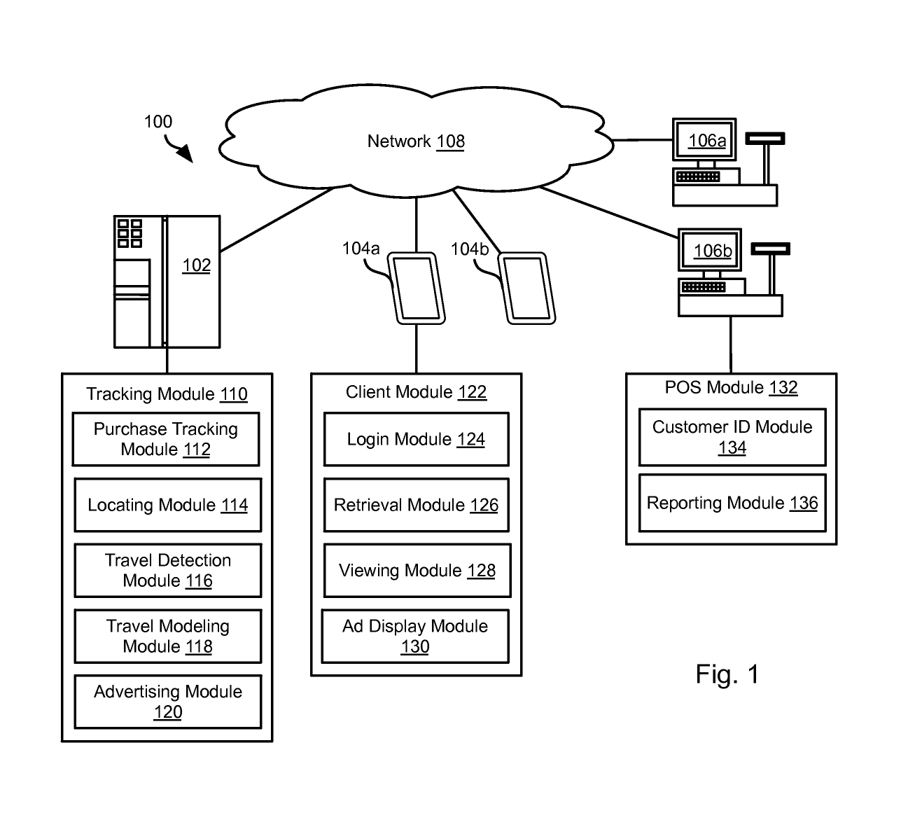

FIG. 1 illustrates a system 100 in which methods described hereinbelow may be implemented. The system 100 may include a server system 102 that may be embodied as one or more server computers each including one or more processors that are in data communication with one another. The server system 102 may be in data communication with one or more user computers 104a, 104b and one or more point of sale (POS) devices 106a, 106b. In the methods disclosed herein, the user computers 104a, 104b are advantageously mobile devices such as a mobile phone or tablet computer. As known in the art, many mobile phones and tablet computers also include cameras that can be used to scan optical codes such as barcodes, quick response (QR) codes, or textual information. In some embodiments, some or all of the methods disclosed herein may be performed using a desktop computer or any other computing device as the user computer 104a, 104b. For purposes of this disclosure, discussion of communication with a user or entity or activity performed by the user or entity may be interpreted as communication with a computer 104a, 104b associated with the user or entity or activity taking place on a computer associated with the user or entity. A POS 106a-106b may be located within a store and may be part of a POS network. In some embodiments, a POS 106a, 106b may be operable to process online transactions. In some embodiments, separate computers of the server system 102 may handle communication with the user computers 104a, 104b and POS 106a, 106b.

Some or all of the server 102, user devices 104a, 104b, and POS 106 may communicate with one another by means of a network 108. The network 108 may be embodied as a peer-to-peer wireless connection between devices, a connection through a local area network (LAN), WiFi network, the Internet, or any other communication medium or system.

The server system 102 may be associated with a merchant, or other entity, providing one or both of electronic receipt archiving and purchase activity-monitoring services. The server system 102 may host or access a tracking module 110. The tracking module 110 may include a purchase tracking module 112, locating module 114, travel detection module 116, a travel modeling module 118, and an advertising module 120.

The tracking module 110 may receive reports of purchases either reported by users or received from a POS 106a, 106b. The tracking module 110 may receive transaction information including purchases of a user from the POS 106a, 106b in the form of electronic receipts or the transaction descriptors that identify the user, e.g., with a unique user identifier. The tracking module 110 may maintain purchase histories for individual users. The tracking module 110 may additionally characterize a user's purchase history to generate a user purchasing profile. The tracking module 110 may also access user attributes such as user demographic data (age, residence, gender) and the like. In some embodiments, one or more of the user attributes may be inferred from an analysis of the user's purchase history. In particular, the home region, e.g. city or neighborhood, of a user may be inferred from a location of a POS 106a, 106b from which transaction information is received. The tracking module 110 may also store self-reported preferences of the user to augment the user profile generated from an analysis of the purchase history.

The locating module 114 may perform tasks involving determining the location of a consumer. For example, a user computing device 104a, 104b may transmit the user's location to the locating module 114. Many smart phones and tablet computers include global positioning system (GPS) receivers that are able to determine the device's location with high precision. Accordingly, the user computing device 104a, 104b may transmit this position to the server system 102. A user computing device 104a, 104b may also be aware of its position based on the location of a cellular antenna with which it establishes a connection. This inferred location may be transmitted by the user computing device 104a, 104b to the server system 102 or may be extracted by the server system 102 from connection parameters during a period in which the user computing device 104a, 104b is in communication with the server system 102 or some other device. The locating module 114 may also infer the user's location from the location of a POS 106, 106b from which the server system 102 receives electronic receipt information. For example, in order to associate a transaction with the user, a user may input an identifier to the POS 106a, 106b, such as by scanning an optical code on a card possessed by the user. Upon receiving transaction information identifying the user, the location of the POS 106a, 106b may be retrieved, such as from a database describing the POS network or store locations for a merchant. This location may then be inferred to be close to the current location of the user.

The travel detection module 116 may make a prediction as to whether a user is traveling. Although a user may shop at various locations and may be located at various places during the course of ordinary events, some movements may be more indicative of the user traveling. For example, over a significant period of time, e.g. from 1 month to a year, a home region in which N % (e.g. 95 or some other percentage) of the user's detected positions are found may be determined. Detected locations of the user that are outside of this home region by a threshold amount may indicate that the user is traveling or otherwise away from home. In some embodiments, the threshold amount may be a multiple, or some other function, of the size (e.g., diameter of smallest enclosing circle) of the user's home region.

The travel modeling module 118 may provide a model for predicting user behavior or otherwise selecting targeted advertising for people that are traveling. Examples of methods that may be used to select advertisements for traveling consumers are described in greater detail below. The advertising module 120 may transmit advertisements for display to a user, such as on a user computing device 104a, 104b.

A user computing device 104a, 104b may host, or otherwise interface with, a client module 122. The client module 122 may include a login module 124, a retrieval module 126, a viewing module 128, and an advertising module 130.

A login module 124 may enable a user to login to the server system 130 in order to request or otherwise access electronic transaction data maintained by the server system 102. The transaction data may be in the form of electronic receipts for transactions conducted on a POS 106a, 106b. The login module 124 may transmit to the server system 102 login information such as a username and password to the server system 102. The login 124 may also transmit a user's location as part of the login process. As already noted the user's location may be determined from a GPS receiver or proximity to a cell phone antenna. As also noted, in some embodiments, a user's location may be inferred from the location of a POS 106a, 106b at which a user conducts a transaction. In such embodiments, this information may supplement or replace location information reported by the login module 124 or otherwise explicitly provided by the user or user computing device 104a, 104b. In some embodiments, a user's location may be reported by the client module 122 during use of the client module 122 by the user or as the client module 122 executes as a background process independent of the act of logging in to the server system 102.

The client module 122 may include any application for providing any functionality relating to an entity operating the server system 102 or on whose behalf the server system 102 provides the functionality described herein. The client module 122 may be embodied as a web page accessed by means of a browser executing on the user computing device 104a, 104b. In the illustrated embodiment, the client module 122 provides access to electronic transaction information, such as electronic receipts, reported by one or more POS 106a, 106b and archived by the server system 102. Accordingly, the client module 122 may include a retrieval module 126 that is effective to retrieve electronic transaction data from the server system 102 either on request of the user or as part of an automated synchronization initiated by the client module 122 or the server system 102.

The client module 122 may further include a viewing module 128 for visually representing electronic transaction data. For example, the viewing module 128 may allow a user to view lists of transactions, sort transactions, filter transactions, select a transaction for display, and visually represent a selected transaction, such as in the form of an electronic receipt.

The client module 122 may further include an advertisement display module 130. The advertisement display module 130 may receive advertisements selected in accordance with methods described herein. The advertisements may be loaded onto the user computing device 104a, 104b and then selected according to methods disclosed herein for display by the advertisement display module 130. The advertisements may be selected by the server system 102 in accordance to methods disclosed herein and then transmitted to the user computing device 104a, 104b for display by the advertisement display module 130. The advertisements may be displayed in any context of the user's use of the client module 122, such as in the form of banner advertisements, sponsored links, product recommendations, targeted coupons, targeted offers, or the like.

For example, the client module 122 may be used to assist a user when shopping at a store by providing access to a product catalog, shopping lists generated by a user, or to access assistance in locating items. In this or other contexts, the client module may associate targeted advertisements as generated herein with content generated by the user or requested by the user. Another context where targeted advertisements may be displayed is upon accessing by the user, such as by means of the client module 122, electronic receipt data. In some embodiments, a client module 122 may present push notifications of when such data is received or notification of availability of such data is received. Such push notifications and corresponding electronic receipt data may be accompanied by advertisements selected according to methods described herein when displayed to the user.

A POS 106a, 106b may host, or otherwise interact with, a POS module 132. The POS module 132 may include a customer identification module 134 and a reporting module 136. A customer identification module 134 may provide means for receiving or otherwise detecting the identity of a consumer conducting a transaction at the POS 106a, 106b. For example, a loyalty card or other device bearing an optical code may be scanned by the POS 106a, 106b and may be associated with the transaction or used to retrieve a user identifier for associating with the transaction. The customer identification module 134 may also issue a prompt to a cashier or customer to input a user identifier and receive the user identifier as input to the POS 106a, 106b.

The reporting module 136 may be operable to transmit details of a transaction from the POS 106a, 106b to the server system 102. The details of a transaction may include the items purchased, the amount paid, the manner of payment, a transaction identifier, the customer identifier or scanned optical code, and like information.

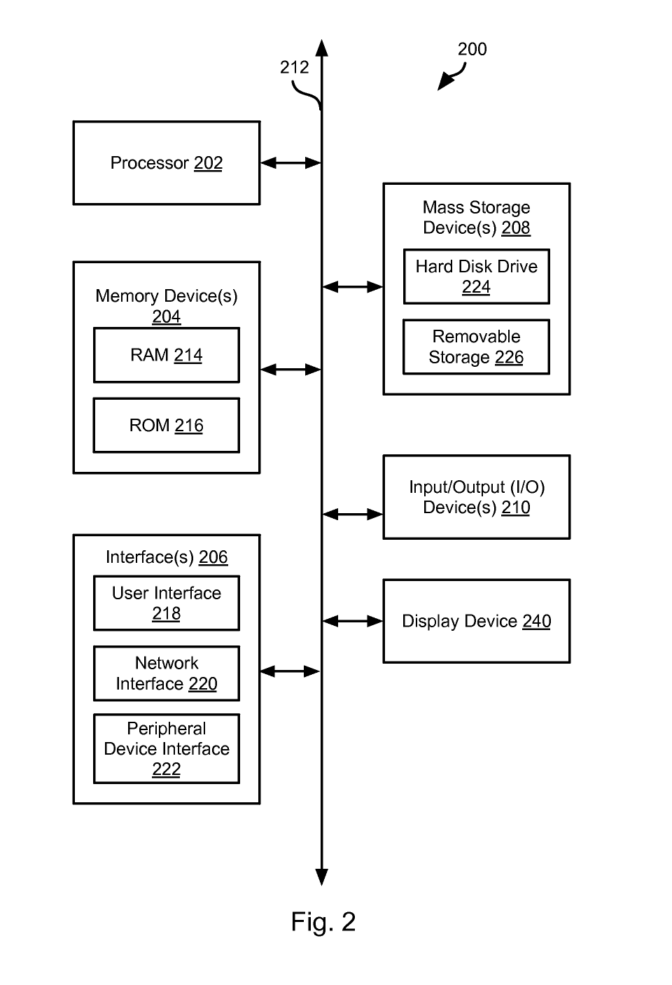

FIG. 2 is a block diagram illustrating an example computing device 200. Computing device 200 may be used to perform various procedures, such as those discussed herein. A server system 102, user computer 104a, 104b, and POS 106a, 106b may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, tablet computer and the like.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more user interface elements 218. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, and I/O device(s) 210 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

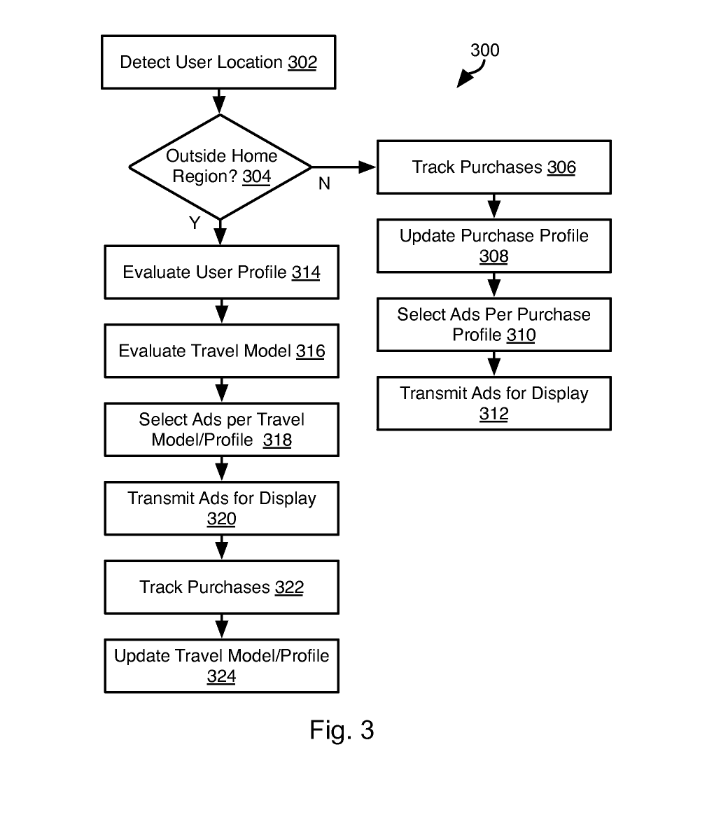

FIG. 3 illustrates a method 300 for generating targeted advertisements. The method 300 may include detecting 302 a user's location according to one or more of the methods described above. The method 300 may include evaluating 304 whether the user's location is outside the user's home region, or a threshold amount outside of the user's home region. If not, then the user's purchases may be tracked 306 and the user's profile updated according to the tracked purchases. As already noted, a user's profile may include any attributes that may be inferred from a user's purchases, a characterization of the user's tastes, a characterization of the user's purchase habits (brand preference, product category preferences, and the like), and any other information known in the art that may be inferred from a user's purchases using any method known in the art for profiling a user based on purchasing activity.

The user profile may be viewed as a model of the user's behavior and may include or be embodied as parameters for a machine learning algorithm that is trained according to the user's purchasing behavior. In such embodiments, the algorithm may be further trained by comparing advertising generated according to the methods described herein and subsequent purchasing behavior tracked as described herein. For example, the model may indicate a correspondence between prior purchases, advertisements selected according to the prior purchases, and subsequent purchases that correspond to the advertisements. Other advertisements to which the user is exposed and other purchasing behavior may also be used to train the algorithm. Advertisements may then be selected 310 in accordance with the user profile and transmitted 312 for display to the user, such as by means of email, banner ads in web pages, or advertisements displayed during a user's use of a client module 122.

If the user is found 304 to be outside of the user's home region, or a threshold amount outside of the user's home region, then advertisements may be selected according to a different model or profile. For example, the user's profile may be evaluated 314 along with evaluating 316 a travel model. A travel model may represent a model that is not specific to a particular user but rather is predictive of purchases likely to be of interest to consumer's in general when traveling. Inasmuch as people generally travel much less than they remain in their home region, there may be insufficient data to profile a user's purchase habits while traveling. Likewise, a user's purchasing profile when in the user's home region is not necessarily indicative of purchases the user is likely to make while traveling. Accordingly, when consumers are detected to be traveling, purchases made may be used to update a generic model. The model may take as inputs such information as a attributes of a user (age, gender, etc.).

The model may also take as inputs information gathered about an individual user. For example, where sufficient data exists, separate models may be maintained for different consumer categories. For example, a consumer categories may be “18-24 year old male college student,” “18-29 year old mother of a young child,” “middle aged male outdoor enthusiast” or the like. Accordingly, a user may be assigned to one of these consumer categories based on analysis of the user's profile as one or both of reported by the user and determined form analysis of the user's purchasing activities. In such embodiments, evaluating 316 a travel model may therefore include evaluating a travel model corresponding to the consumer's attributes and habits. Evaluating 314 a user profile may include extracting sufficient information to assign the user to a consumer group or retrieving a pre-assigned consumer group from the user's profile.

Advertisements relating to subject matter that the travel model indicates will be of interest to the user may then be selected 318 and transmitted 320 for display to the user. The user's purchases subsequent to transmission 320 of the selected advertisement may be tracked 322 and the user's purchases may be used to update one or more of a generic travel model, a travel model for the user's consumer category, and a travel model specific to the user.

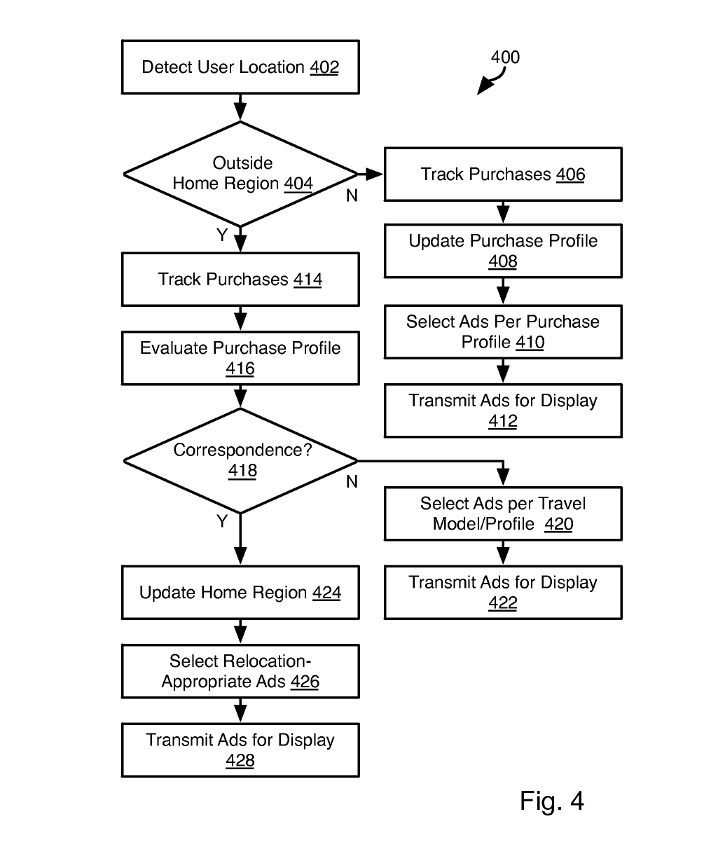

FIG. 4 illustrates an alternative method 400 for generating targeted advertisements that may be performed in the place of or in combination with the method 300. In the same manner as the method 300 a user's location may be detected 402 and evaluated 404 with respect to a home region identified for the user. If the detected location is not found 404 to be outside, or a threshold amount outside, the user's home region, the method 400 may include performing one or more of the steps of tracking 406 the user's purchases, updating 408 a user's purchase profile, selecting 410 advertisements for display to the user, and transmitting 412 the advertisements for display to the user in the same manner as described above with respect to the method 300.

If the user is found 404 to be outside the user's home region, the method 400 may include tracking 414 the user's purchases while away from the home region and the user's purchase profile. The method 400 may include determining 418 according to the evaluations 414, 416 whether the away purchases correspond to the user's purchases in the home region. If not, then the user may be presumed to be traveling and advertisements may be selected 420 and transmitted 422 for display to the user in the manner described above with respect to the method 300. The user's purchases may likewise be used to update one or more of a generic travel model, a consumer category travel model, and the user's travel profile in the same manner as described above with respect to the method 300.

If a correspondence is found 418 between the user's away purchase and the user's purchase profile, then the user may be presumed to have moved to a new area and the user's home region may be updated 424. In some embodiments, correspondence between away purchases over an extended period, e.g. between two weeks and one month, and the user's purchase profile may be required before correspondence is found 418 or the user's home region is updated 424 to be the user's detected 402 location.

If correspondence is found 418 then the method 400 may further include selecting 426 relocation appropriate advertisements and transmitting 428 these advertisements for display to the users. As for other embodiments disclosed herein the relocation appropriate advertisements may be in accordance with a model that is updated and trained according to monitored purchasing behavior of consumers. For example, for consumers found to have relocated, the purchasing behavior of these consumers to these advertisements may be monitored and used to train the model to select effective advertisements for relocating consumers. Also in a like manner to embodiments disclosed herein, separate profiles or models may be maintained for consumers corresponding to various consumer categories.

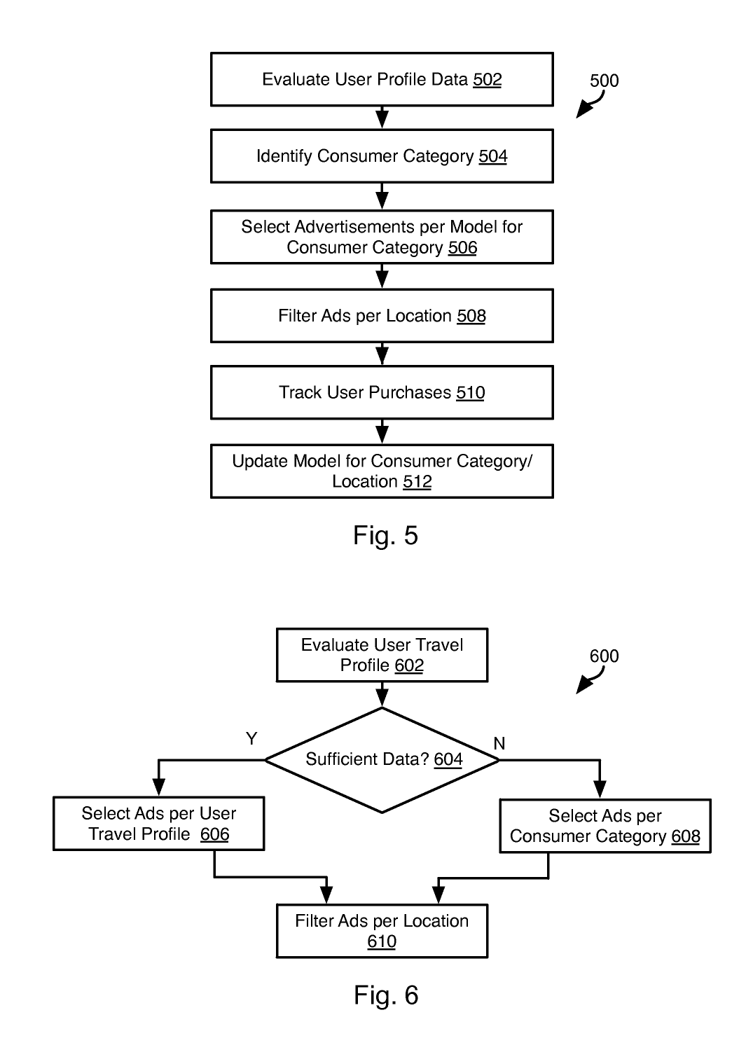

FIG. 5 illustrates an example of a method 500 for generating targeted advertising for a consumer while traveling. The method 500 may be used to generate targeted advertisements for a user found to be traveling in accordance with the methods described herein. The method 500 may include evaluating 502 the user's profile and identifying 504, in accordance with the evaluation 502, a consumer category from a set of predefined consumer categories, or a creating a new consumer category for the user.

Over time, purchases of consumers identified to be traveling and belonging to a particular category may be analyzed to identify purchasing behaviors of that consumer category. Likewise, responses of consumers to advertisements generated based on these identified behaviors may also be tracked and used to update a model for selecting advertisements of traveling consumers belonging to the consumer category. Accordingly, using the model for the identified 504 consumer category, advertisements for the user may be selected 506. In some embodiments, the selected advertisements may be filtered 508 according to appropriateness to the location to which the user has traveled. For example, where the location of the traveling user is experiencing winter weather, advertisements not appropriate for this condition may be removed. Likewise, a traveling consumer near a beach may only be presented advertisements that are consistent therewith. As for other embodiments disclosed herein, the user's purchases may be tracked 510 and the model for that consumer category or user may be updated 512.

For all of the illustrated embodiments disclosed herein a generic travel model or consumer category model for a traveling consumer may be geography specific. That is to say for a region or location a model may be maintained according to any of the methods described herein that takes as training data user purchases in that region or location, either in a generic sense or subdivided according to consumer category. Accordingly, updating 512 the model may include updating a generic model or consumer category model corresponding to the user's location at which tracked purchases were made.

FIG. 6 illustrates a method 600 for selecting an advertisement-selection model for a traveling consumer. The method 600 assumes that while traveling a travel profile of the user is updated for tracked purchases detected while the user is traveling. The traveling purchases may be separated from purchases occurring in the home region in order to avoid distorting the user's home purchase profile with uncharacteristic purchases. The method 600 may include evaluating 602 the travel profile of the user and, in accordance with the evaluation, determining 504 whether sufficient data exists in the travel profile to generate targeted advertising based thereon. If so, then advertisements may be selected 606 according to the user's travel profile in accordance with any of the methods described herein. Otherwise, advertisements may be selected 608 according to one of a generic traveling consumer model and a consumer category model corresponding to the user. The selected advertisements may then be further filtered 610 according to the user's location as described above. The selected and/or filtered advertisements and the user's response thereto may then be processed according to other methods described herein.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A method for generating advertisements, the method comprising:
tracking, by a computer system, local purchases of a user within a home region of the user;
selecting, by a computer system, first advertisements according to a first model trained according to the tracked local purchases of the user;
transmitting, by a computer system, the first advertisements for display to the user;
detecting, by the computer system, presence of the user outside of the home region;
selecting, by the computer system, second advertisements according to a second model that is different from the first model upon detecting location of the user outside of the home region; and
transmitting, by the computer system, the second advertisements for display to the user.

2. The method of claim 1, further comprising suspending selection of first advertisements according to the first model upon detecting location of the user outside of the home region.

3. The method of claim 1, further comprising:
receiving purchase information from a plurality of consumers while away from the home regions of the plurality of consumers; and
updating the second model according to the purchase information from the plurality of consumers.

4. The method of claim 1, further comprising:
tracking away purchases of the user occurring outside of the home region; and
updating a travel profile of the user according to the away purchases of the user;
wherein selecting second advertisements according to the second model further comprises selecting the second advertisements according to the second model trained according to the travel profile of the user if sufficient away purchases have been tracked.

5. The method of claim 4, wherein selecting second advertisements according to the second model further comprises selecting the second advertisements according to the second model trained according to away purchases of a plurality of consumers if sufficient away purchases have not been tracked for the user.

6. The method of claim 1, further comprising identifying a consumer category for the user according to at least one of the tracked local purchases of the user and demographic data of the user; wherein
wherein the first model is a model corresponding to the consumer category.

7. The method of claim 1, wherein detecting presence of the user outside of the home region further comprises detecting the location of the user from a global positioning system reading from a mobile device of the user.

8. The method of claim 1, wherein detecting presence of the user outside of the home region further comprises detecting login of the user to a merchant application, the login having a user position associated therewith.

9. The method of claim 1, wherein detecting presence of the user outside of the home region further comprises receiving electronic receipt data identifying the user from a point of sale having a location outside of the home region.

10. The method of claim 1, further comprising:
detecting away purchases of the user while outside of the home region;
comparing the away purchases to the tracked local purchases; and
selecting third advertisements according to a third model if the away purchases correspond to the tracked local purchase, the third model predictive of purchase preferences of consumers upon moving to a new area.

11. A system for generating advertisements, the system comprising one or more processors and one or more memory devices operably coupled to the one or more processors, the one or more memory devices storing executable and operational data effective to cause the one or more processors to:
track local purchases of a user within a home region of the user;
select first advertisements according to a first model trained according to the tracked local purchases of the user;
transmit the first advertisements for display to the user;
detect presence of the user outside of the home region;
selecting second advertisements according to a second model that is different from the first model upon detecting location of the user outside of the home region; and
transmitting the second advertisements for display to the user.

12. The system of claim 11, wherein the executable and operational data are further effective to cause the one or more processors to suspend selection of first advertisements according to the first model upon detecting location of the user outside of the home region.

13. The system of claim 11, wherein the executable and operational data are further effective to cause the one or more processors to:
receive purchase information from a plurality of consumers while away from the home regions of the plurality of consumers; and
update the second model according to the purchase information from the plurality of consumers.

14. The system of claim 11, wherein the executable and operational data are further effective to cause the one or more processors to:
track away purchases of the user occurring outside of the home region; and
update a travel profile of the user according to the away purchases of the user; and
wherein the executable and operational data are further effective to cause the one or more processors to select second advertisements according to the second model by selecting the second advertisements according to the second model trained according to the travel profile of the user if sufficient away purchases have been tracked.

15. The system of claim 14, wherein the executable and operational data are further effective to cause the one or more processors to select second advertisements according to the second model by selecting the second advertisements according to the second model trained according to away purchases of a plurality of consumers if sufficient away purchases have not been tracked for the user.

16. The system of claim 11, wherein the executable and operational data are further effective to cause the one or more processors to identify a consumer category for the user according to at least one of the tracked local purchases of the user and demographic data of the user; wherein
wherein the first model is a model corresponding to the consumer category.

17. The system of claim 11, wherein the executable and operational data are further effective to cause the one or more processors to detect presence of the user outside of the home region by detecting the location of the user from a global positioning system reading from a mobile device of the user.

18. The system of claim 11, wherein the executable and operational data are further effective to cause the one or more processors to detect presence of the user outside of the home region by detecting login of the user to a merchant application, the login having a user position associated therewith.

19. The system of claim 11, wherein the executable and operational data are further effective to cause the one or more processors to detect presence of the user outside of the home region by receiving electronic receipt data identifying the user from a point of sale having a location outside of the home region.

20. The system of claim 11, wherein the executable and operational data are further effective to cause the one or more processors to:
detect away purchases of the user while outside of the home region;
compare the away purchases to the tracked local purchases; and
select third advertisements according to a third model if the away purchases correspond to the tracked local purchase, the third model predictive of purchase preferences of consumers upon moving to a new area.
